(19) United States
(12) Patent Application Publication
(10) Pub. No.: US 2025/0102375 A1
(43) Pub. Date: Mar. 27, 2025

(54) FORCE SENSOR

(71) Applicants: HONDA MOTOR CO., LTD., Tokyo (JP); The University of British Columbia, Vancouver (CA)

(72) Inventors: Ryusuke Ishizaki, Wako-shi (JP); Takeshi Osato, Wako-shi (JP); Fumiya Hamatsu, Wako-shi (JP); Xiaoxiao Xiong, Vancouver (CA); Jian Gao, Vancouver (CA); Chrysanthemum Morton, Vancouver (CA); John D W Madden, Vancouver (CA); Xiulun Yin, Vancouver (CA); Yizhong Chen, Vancouver (CA); Nischay Joshi, Vancouver (CA)

(21) Appl. No.: 18/890,807

(22) Filed: Sep. 20, 2024

(30) Foreign Application Priority Data
Sep. 25, 2023 (JP) 2023-161512

(51) Int. Cl. G01L 1/14; G01L 25/00

(52) U.S. Cl. CPC G01L 1/142; G01L 25/00

(57) ABSTRACT

A force sensor includes: a dielectric elastic base material; and a first electrode and three second electrodes that sandwich the elastic base material from both sides in a thickness direction. In a plan view seen along the thickness direction, the three second electrodes are arranged to overlap portions of the first electrode that are different from one another. In each case where an external force acts on the elastic base material along each of a first direction and a second direction that form a predetermined angle on a plane orthogonal to the thickness direction, among areas of the portions where each of the three second electrodes overlaps the first electrode, the areas corresponding to at least two of the second electrodes change.

### CROSS-REFERENCE TO RELATED APPLICATION

Priority is claimed on Japanese Patent Application No. 2023-161512, filed on Sep. 25, 2023, the contents of which are incorporated herein by reference.

### BACKGROUND

### Field of the Invention

The present invention relates to a force sensor.

### Background

In the related art, a flexible capacitance-type triaxial force sensor that includes four first electrodes (circumferential electrodes) and a second electrode (common electrode) sandwiching a dielectric which elastically deforms from both sides in a thickness direction is known (for example, refer to Japanese Unexamined Patent Application, First Publication No. 2022-111489).

### SUMMARY

For example, in the case of a sensor device that is attached to a portion where the layout space is limited such as a robot hand, it is desired to reduce the number of electrodes and the number of wires. For example, when the number of electrodes and the number of wires are large, a problem arises that the layout in a small space becomes difficult. For example, when the number of wires is large, a problem arises that it becomes difficult to increase a S/N ratio of a sensor due to an increase of a crosstalk between wires. For example, when the number of electrodes per each of a plurality of sensor elements constituting a sensor array is large, the number of times of measuring a capacitance value of each electrode is increased, and thereby, a problem arises that a process time is increased. For example, when the number of flexible wires is large, a problem arises that the possibility of abnormality occurrence is increased due to a low joint strength in a circuit.

An aspect of the present invention aims at providing a force sensor capable of preventing an increase of the number of electrodes and the number of wires.

A force sensor according to a first aspect of the present invention includes: a dielectric elastic base material; and a first electrode and three second electrodes that sandwich the elastic base material from both sides in a predetermined direction, wherein in a plan view seen along the predetermined direction, the three second electrodes are arranged to overlap portions of the first electrode that are different from one another, and in each case where an external force acts on the elastic base material along each of a first direction and a second direction that form a predetermined angle on a plane orthogonal to the predetermined direction, among areas of the portions where each of the three second electrodes overlaps the first electrode, the areas corresponding to at least two of the second electrodes change.

A force sensor according to a second aspect of the present invention includes: a dielectric elastic base material; and a plurality of electrode elements that are integrally aligned, each of the plurality of electrode elements being a combination of a first electrode and three second electrodes that sandwich the elastic base material from both sides in a predetermined direction, wherein in a plan view seen along the predetermined direction, the three second electrodes are arranged to overlap portions of the first electrode that are different from one another in each the plurality of electrode elements, and each of the three second electrodes in the plurality of electrode elements is aligned along three different straight lines that are parallel to one another.

A third aspect is the force sensor according to the first or second aspect described above which may further include: a process portion that sets, with reference to any one of the three second electrodes, a correction coefficient of a capacitance to other two second electrodes in accordance with the areas of the portions where each of the three second electrodes overlaps the first electrode, and acquires an external force that acts on the elastic base material based on the correction coefficient and the capacitance of each of the three second electrodes.

According to the first aspect described above, by the combination of the first electrode and the three second electrodes, it is possible to detect the action of a three-dimensional external force by a capacitance change, and it is possible to prevent the increase of the number of electrodes and the number of wires, for example, compared to the case where four or more second electrodes are provided or the like.

According to the second aspect described above, in the plurality of electrode elements, each of the three second electrodes is arranged in a straight line form parallel to one another, and thereby, it is possible to prevent an increase of a crosstalk between wires, for example, compared to the case where the three second electrodes are arranged along straight lines intersecting one another or the like.

In the case of the third aspect described above, even when the areas of the portions that overlap the first electrode are different among the three second electrodes, by including the process portion that sets the correction coefficient of the capacitance with reference to any one of the three second electrodes, it is possible to properly detect a capacitance change caused by the action of a three-dimensional external force.

### BRIEF DESCRIPTION OF THE DRAWINGS

FIG. 1 is a configuration view of a force sensor of an embodiment of the present invention when seen along a thickness direction (Z-axis direction).

FIG. 2 is a cross-sectional view showing the force sensor of the embodiment of the present invention broken in a plane (Y-Z plane) parallel to the thickness direction (Z-axis direction) at a position of an A-A line shown in FIG. 1.

FIG. 3 is a view of a state where an external force along a Y-axis direction acts on the force sensor of the embodiment of the present invention when seen along the thickness direction (Z-axis direction).

FIG. 4 is a configuration view of an array-type force sensor in the embodiment of the present invention when seen along the thickness direction (Z-axis direction).

FIG. 5 is a cross-sectional view showing a force sensor according to a first modification example of the embodiment of the present invention broken in a Y-Z plane.

FIG. 6 is a cross-sectional view showing a force sensor according to a second modification example of the embodiment of the present invention broken in the Y-Z plane.

FIG. 7 is a configuration view of an array-type force sensor according to a third modification example of the embodiment of the present invention when seen along the thickness direction (Z-axis direction).

FIG. 8 is a configuration view of a force sensor according to a fourth modification example of the embodiment of the present invention when seen along the thickness direction (Z-axis direction).

FIG. 9 is a configuration view of a force sensor according to a fifth modification example of the embodiment of the present invention when seen along the thickness direction (Z-axis direction).

FIG. 10 is a configuration view of a force sensor according to a sixth modification example of the embodiment of the present invention when seen along the thickness direction (Z-axis direction).

FIG. 11 is a configuration view of a force sensor according to a seventh modification example of the embodiment of the present invention when seen along the thickness direction (Z-axis direction).

FIG. 12 is a configuration view of an array-type force sensor according to the seventh modification example of the embodiment of the present invention when seen along the thickness direction (Z-axis direction).

FIG. 13 is a cross-sectional view showing part of the array-type force sensor according to the seventh modification example of the embodiment of the present invention broken in a X-Y plane.

### DESCRIPTION OF EMBODIMENTS

Hereinafter, a force sensor according to an embodiment of the present invention will be described with reference to the attached drawings.

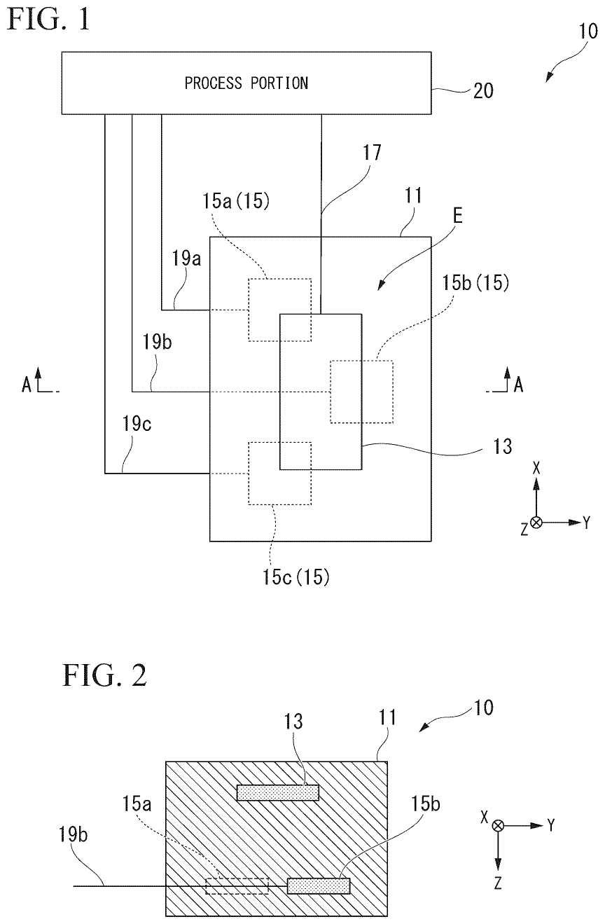

FIG. 1 is a configuration view of a force sensor 10 of an embodiment when seen along a thickness direction (Z-axis direction).

FIG. 2 is a cross-sectional view showing the force sensor 10 of the embodiment broken in a plane (Y-Z plane) parallel to the thickness direction (Z-axis direction) at a position of an A-A line shown in FIG. 1.

In the following description, each axis direction of an X-axis, a Y-axis, and a Z-axis that are orthogonal to one another in a three-dimensional space is a direction parallel to each axis of the force sensor 10. For example, as shown in FIG. 1 and FIG. 2, a Z-axis direction is parallel to the thickness direction of the force sensor 10, and an X-axis direction and a Y-axis direction are parallel to orthogonal directions of the thickness direction.

The force sensor 10 of the embodiment is, for example, a flexible circuit device (flexible and stretchable circuit device) that is attached to or worn on a human body or a robot and has flexibility and a stretch property. The force sensor 10 of the embodiment is, for example, a flexible capacitance-type triaxial force sensor.

As shown in FIG. 1 and FIG. 2, the force sensor 10 includes, for example, a dielectric elastic base material 11, a first electrode 13, three second electrodes 15 (15a, 15b, 15c), a first conductor wire 17, three second conductor wires 19a, 19b, 19c, and a process portion 20.

The dielectric elastic base material 11 is, for example, a flexible dielectric such as a so-called thermosetting elastomer.

The first electrode 13 and the three second electrodes 15 are formed of, for example, a conductive material having flexibility and a stretch property such as a resin including a conductive metal filler. An outer shape of the first electrode 13 is, for example, a rectangular plate shape. An outer shape of each of the three second electrodes 33 is, for example, a rectangular plate shape having a size smaller than that of the first electrode 13 and identical to one another.

The first electrode 13 and the three second electrodes 15 constitute one electrode element E. The first electrode 13 and the three second electrodes 15 are arranged inside the elastic base material 11, for example, in a state of facing each other at a predetermined interval in the thickness direction so as to sandwich part of the elastic base material 11 from both sides in the thickness direction (Z-axis direction).

For example, in a plan view seen along the thickness direction, the three second electrodes 15a, 15b, 15c are arranged so as to overlap portions of the first electrode 13 that are different from one another.

Among the three second electrodes 15a, 15b, 15c, two second electrodes 15a, 15c are arranged so as to overlap two predetermined corner portions adjacent to each other among four corner portions of the first electrode 13. Among the three second electrodes 15a, 15b, 15c, the remaining one second electrode 15b is arranged so as to overlap a portion between two corner portions other than the two predetermined corner portions adjacent to each other among the four corners of the first electrode 13.

For example, in a state where an external force does not act, areas of regions where the two second electrodes 15a, 15c among the three second electrodes 15a, 15b, 15c overlap the first electrode 13 are the same as each other. The total area of the regions where the two second electrodes 15a, 15c overlap the first electrode 13 is the same as an area of the region where the remaining one second electrode 15b overlaps the first electrode 13.

Each of the first conductor wire 17 and the three second conductor wires 19a, 19b, 19c is formed of, for example, a conductive material having flexibility and a stretch property such as a resin including a conductive metal filler.

The first conductor wire 17 connects the first electrode 13 to the process portion 20. The three second conductor wires 19a, 19b, 19c connect the three second electrodes 15a, 15b, 15c to the process portion 20. The three second conductor wires 19a, 19b, 19c are arranged, for example, in parallel with one another without intersecting one another on an identical plane (X-Y plane) orthogonal to the thickness direction.

For example, in a plan view seen along the thickness direction, the first conductor wire 17 and each of the three second conductor wires 19a, 19b, 19c are arranged along a first straight line and a second straight line that intersect each other at a predetermined angle. The first conductor wire 17 is arranged in parallel with the first straight line. Each of the three second conductor wires 19a, 19b, 19c is arranged in parallel with the second straight line. The first straight line and the second straight line are, for example, an X-axis line and a Y-axis line that are orthogonal to each other.

The process portion 20 is, for example, a software function unit that functions by a predetermined program being executed by a processor such as a CPU (Central Processing Unit). The software function unit is an ECU that includes the processor such as a CPU, a ROM (Read Only Memory) that stores the program, a RAM (Random Access Memory) that temporarily stores data, and an electronic circuit such as a timer. At least part of the process portion 20 may be an integrated circuit such as a LSI (Large Scale Integration).

For example, the process portion 20 treats a combination of one first electrode 13 and three second electrodes 15a, 15b, 15c as one electrode element E and transmits and receives an input signal and an output signal for detecting a capacitance via the first conductor wire 17 and the three second conductor wires 19a, 19b, 19c between each electrode element E and the process portion 20. The process portion 20 acquires the capacitance of each electrode element E on the basis of the input signal and the output signal with respect to each electrode element E. The process portion 20 detects a change in capacitance due to deformation of the elastic base material 11 between the first electrode 13 and the three second electrodes 15a, 15b, 15c caused by the action of an external force. The process portion 20 detects the magnitude, the distribution, and the like in three axis directions (the X-axis direction, the Y-axis direction, and the Z-axis direction that are orthogonal to one another) of the external force that acts on each electrode element on the basis of the change in capacitance.

For example, as shown in table 1 below, each capacitance C1, C2, C3 by the first electrode 13 and each of the three second electrodes 15a, 15b, 15c shows a change in accordance with an action direction of an external force.

TABLE 1

| EXTERNAL FORCE | CAPACITANCE CHANGE | | |
|---|---|---|---|
| ACTION DIRECTION | C1 | C2 | C3 |
| X-AXIS | INCREASE | NO CHANGE | DECREASE |
| POSITIVE DIRECTION | | | |
| X-AXIS | DECREASE | NO CHANGE | INCREASE |
| NEGATIVE DIRECTION | | | |
| Y-AXIS | DECREASE | INCREASE | DECREASE |
| POSITIVE DIRECTION | | | |
| Y-AXIS | INCREASE | DECREASE | INCREASE |
| NEGATIVE DIRECTION | | | |
| Z-AXIS | INCREASE | INCREASE | INCREASE |
| POSITIVE DIRECTION | | | |
| Z-AXIS | DECREASE | DECREASE | DECREASE |
| NEGATIVE DIRECTION | | | |

In an example shown in Table 1 described above, in each case where an external force acts on the elastic base material 11 along each of the X-axis direction and the Y-axis direction that are orthogonal to each other on an X-Y plane orthogonal to the predetermined direction (Z-axis direction), among areas of the portions where each of the three second electrodes 15 (15a, 15b, 15c) overlaps the first electrode 13, the areas corresponding to at least two of the second electrodes 15 change.

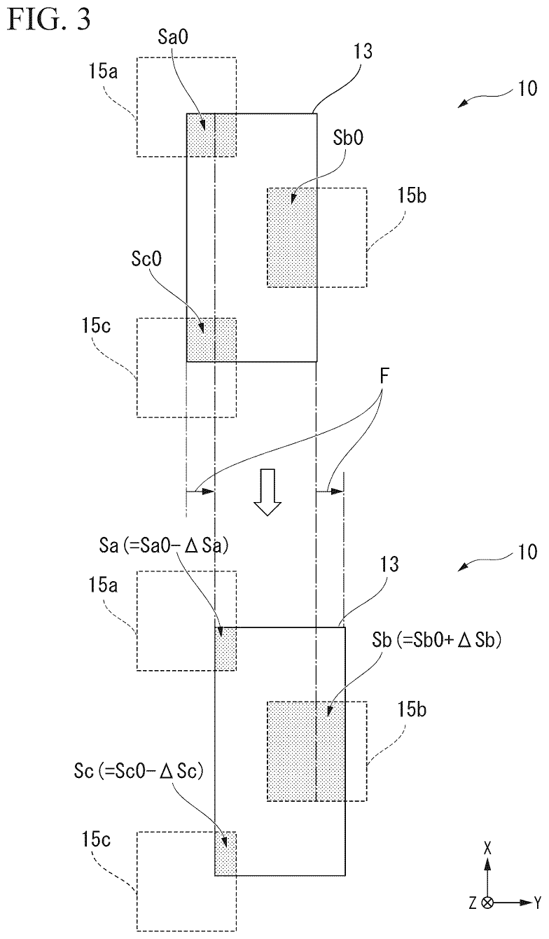

FIG. 3 is a view of a state where an external force along the Y-axis direction acts on the force sensor 10 of the embodiment when seen along the thickness direction (Z-axis direction).

In an example shown in FIG. 3, an external force F along the Y-axis direction acts, and thereby, the first electrode 13 is relatively displaced in a positive direction in the Y-axis direction relative to the three second electrodes 15a, 15b, 15c.

For example, in the plan view seen along the thickness direction, each area change amount ΔSa, ΔSb, ΔSc of a portion where the first electrode 13 overlaps each of the three second electrodes 15a, 15b, 15c is described by each area Sa0, Sb0, Sc0 before displacement and each area Sa, Sb, Sc after displacement as shown in Expression (1) described below.

$$\begin{matrix}[ Expression 1 ] & \\ \begin{matrix}Δ Sa = Sa 0 - Sa \\ Δ Sb = Sb 0 - Sb \\ Δ Sc = Sc 0 - Sc\end{matrix} \} & ( 1 )\end{matrix}$$

Each capacitance Ca, Cb, Cc after the displacement by the first electrode 13 and each of the three second electrodes 15a, 15b, 15c is described by a dielectric constant & of the elastic base material 11, each area Sa, Sb, Sc after the displacement, and a distance d after the displacement in the thickness direction between the first electrode 13 and each of the three second electrodes 15a, 15b, 15c as shown in Expression (2) described below.

$$\begin{matrix}[ Expression 2 ] & \\ \begin{matrix}Ca = ε \times \frac{Sa}{d} \\ Cb = ε \times \frac{Sb}{d} \\ Cc = ε \times \frac{Sc}{d}\end{matrix} \} & ( 2 )\end{matrix}$$

For example, the process portion 20 sets, with reference to any one of the three second electrodes 15a, 15b, 15c, a correction coefficient of a capacitance to other two second electrodes in accordance with each area change amount ΔSa, ΔSb, ΔSc and each area Sa, Sb, Sc after the displacement. For example, with reference to the second electrode 15c, each correction coefficient ηa, ηb set for each of the two second electrodes 15a, 15b is described as shown in Expression (3) described below. The correction coefficient ne of the second electrode 15c, which is the reference, is 1.

$$\begin{matrix}[ Expression 3 ] & \\ \begin{matrix}η a = \frac{Δ Sc}{Δ Sa} = \frac{Sc}{Sa} \\ η b = \frac{Δ Sc}{Δ Sb} = \frac{Sc}{Sb} \\ η c = \frac{Δ Sc}{Δ Sc} = \frac{Sc}{Sc} = 1\end{matrix} \} & ( 3 )\end{matrix}$$

For example, the process portion 20 acquires each capacitance (ηa×Ca), (ηb×Cb), (ηc(=1)×Cc) after correction by multiplying each capacitance Ca, Cb, Cc by each correction coefficient ηa, ηb, ηc(=1) on the basis of Expression (2) described above and Expression (3) described above. The process portion 20 acquires the external force F that acts on the elastic base material 11 on the basis of each capacitance (ηa×Ca), (ηb×Cb), (ηc×Cc) after the correction.

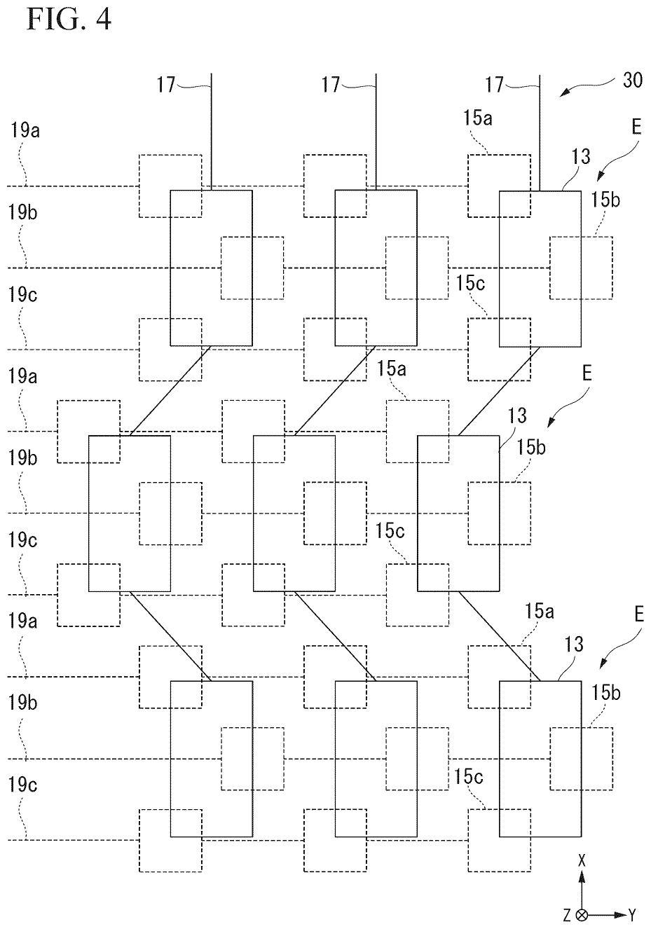

FIG. 4 is a configuration view of an array-type force sensor 30 in the embodiment when seen along the thickness direction (Z-axis direction).

As shown in FIG. 4, the array-type force sensor 30 includes, for example, a dielectric elastic base material 11, a plurality of electrode elements E that are integrally aligned, a plurality of first conductor wires 17, a plurality of sets of second conductor wires 19a, 19b, 19c, and the process portion 20 (not shown).

For example, in a plan view seen along the thickness direction, the plurality of electrode elements E are arranged so as to be aligned and spaced at a predetermined interval in the Y-axis direction in each of a plurality of rows parallel to the Y-axis direction aligned to be spaced at a predetermined interval in the X-axis direction. The arrangement of the plurality of first electrodes 13 and the plurality of second electrodes (15a, 15b, 15c) is, for example, a staggered arrangement.

The plurality of first electrodes 13 are arranged, for example, along the X-axis direction while being displaced alternately in the Y-axis direction in each of a plurality of rows along the X-axis direction aligned to be spaced at a predetermined interval in the Y-axis direction. The plurality of first electrodes 13 are arranged, for example, so as to be aligned and spaced at a predetermined interval along the Y-axis direction in each of a plurality of rows parallel to the Y-axis direction aligned to be spaced at a predetermined interval in the X-axis direction. The plurality of first electrodes 13 that are staggered in each of the plurality of rows aligned in the Y-axis direction are connected, for example, by the first conductor wire 17 that is inclined in an opposite direction of the Y-axis direction alternately with respect to the X-axis direction.

The three second electrodes 15a, 15b, 15c of the plurality of sets are arranged, for example, so as to be aligned and spaced at a predetermined interval along the Y-axis direction in each of a plurality of rows parallel to the Y-axis direction aligned to be spaced at a predetermined interval in the X-axis direction. The plurality of second electrodes 15 are arranged, for example, in a so-called angular staggered (45-degree staggered) form such that an isosceles right triangle is formed when connecting the centers of the adjacent second electrodes 15 by line segments. For example, in each of a plurality of rows aligned in the X-axis direction, a plurality of second electrodes 15a are connected by a second conductor wire 19a parallel to the Y-axis direction, a plurality of second electrodes 15b are connected by a second conductor wire 19b parallel to the Y-axis direction, and a plurality of second electrodes 15c are connected by a second conductor wire 19c parallel to the Y-axis direction.

In the case of the array-type force sensor 30, for example, the process portion 20 sequentially switches and selects any one of the plurality of electrode elements Es to be in a connection state. The process portion 20 sequentially switches a combination of one first conductor wire 17 and one set of second conductor wires 19a, 19b, 19c to be in the connection state from among the plurality of first conductor wires 17 and the plurality of sets of second conductor wires 19a, 19b, 19c. The process portion 20 sets first conductor wires 17 and second conductor wires 19a, 19b, 19c other than the one first conductor wire 17 and the one set of second conductor wires 19a, 19b, 19c to be set in the connection state to a reference potential by grounding or the like. The process portion 20 transmits and receives an input signal and an output signal for detecting the capacitance to and from each electrode element Es to be set in the connection state.

As described above, according to the force sensor 10 of the embodiment, by the combination of one first electrode 13 and three second electrodes 15, it is possible to detect the action of a three-dimensional external force by a capacitance change, and it is possible to prevent the increase of the number of electrodes and the number of wires, for example, compared to the case where four or more second electrodes are provided or the like.

For example, by preventing the increase of the number of electrodes and the number of wires, it is possible to prevent the layout in a small space in a portion where a layout space is limited of a robot hand or the like from becoming difficult. For example, by preventing the increase of the number of wires, it is possible to prevent the increase of the crosstalk between wires and prevent the decrease of the S/N ratio of the force sensor 10. For example, by preventing the increase of the number of electrodes, it is possible to prevent the number of times of measuring a capacitance value of each second electrode 15 from being increased and prevent the increase of the process time. For example, by preventing the increase of the number of flexible wires, it is possible to prevent the possibility of abnormality occurrence due to a low joint strength in the circuit from being increased.

According to the array-type force sensor 30 of the embodiment, in the plurality of electrode elements E, each of the three second electrodes 15 (15a, 15b, 15c) is arranged in a straight line form parallel to one another, and thereby, it is possible to prevent the increase of the crosstalk between wires, for example, compared to the case where the three second electrodes 15 are arranged along straight lines intersecting one another or the like.

Even when the areas of the portions that overlap the first electrode 13 are different among the three second electrodes 15 (15a, 15b, 15c), by including the process portion 20 that sets each correction coefficient ηa, ηb, and ηc to each capacitance Ca, Cb, Cc with reference to any one of the three second electrodes 15, it is possible to properly detect the change of the capacitance caused by the action of a three-dimensional external force.

### Modification Example

Hereinafter, modification examples of the embodiment are described. The same portions as those of the embodiment described above are denoted by the same reference numerals, and descriptions thereof are omitted or simplified.

The above embodiment is described using an example in which the three second conductor wires 19a, 19b, 19c are arranged on the identical plane (X-Y plane); however, the embodiment is not limited thereto. For example, the three second conductor wires 19a, 19b, 19c may be arranged on a different plane from one another that is orthogonal to the thickness direction.

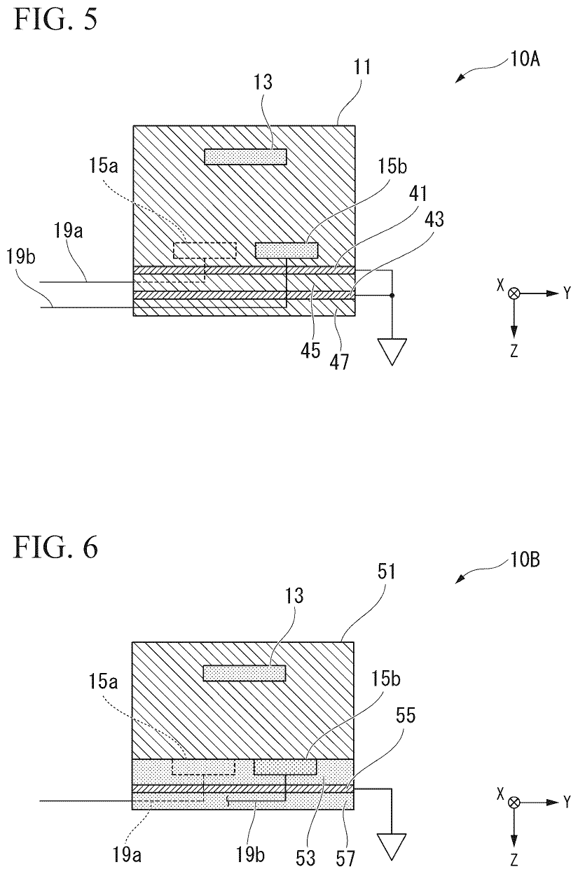

FIG. 5 is a cross-sectional view showing a force sensor 10A according to a first modification example of the embodiment broken in a Y-Z plane similarly to FIG. 2 described above.

As shown in FIG. 5, the force sensor 10A according to the first modification example includes, for example, a first conductor layer 41, a second conductor layer 43, a first dielectric layer 45, and a second dielectric layer 47 in addition to the force sensor 10 of the embodiment described above.

The force sensor 10A according to the first modification example is formed, for example, in a multilayer structure of the elastic base member 11, the first conductor layer 41, the first dielectric layer 45, the second conductor layer 43, and the second dielectric layer 47 that are sequentially laminated in the thickness direction.

Each of the first conductor layer 41 and the second conductor layer 43 is formed of, for example, a conductive material having flexibility and a stretch property such as a resin including a conductive metal filler. The first conductor layer 41 and the second conductor layer 43 are set to a reference potential, for example, by grounding or the like. Each of the first dielectric layer 45 and the second dielectric layer 47 is, for example, a flexible dielectric such as a so-called thermosetting elastomer similarly to the elastic base material 11.

For example, two second conductor wires 19a, 19c penetrate through the first conductor layer 41 along the thickness direction from two second electrodes 15a, 15c in the elastic base material 11 and are arranged in the first dielectric layer 45.

One second conductor wire 19b penetrates through the first conductor layer 41, the first dielectric layer 45, and the second conductor layer 43 sequentially along the thickness direction from one second electrode 15b in the elastic base material 11 and is arranged in the second dielectric layer 47.

According to the first modification example, it is possible to form the shielding between each second electrode 15a, 15b, 15c and each second conductor wire 19a, 19b, 19c and the shielding among the three second conductor wires 19a, 19b, 19c, and it is possible to increase the S/N ratio of the force sensor 10A.

The above embodiment is described using an example in which the three second electrodes 15 (15a, 15b, 15c) are arranged in the elastic base material 11; however, the embodiment is not limited thereto. For example, the three second electrodes 15 may be supported by a substrate having an insulation property or the like.

FIG. 6 is a cross-sectional view showing a force sensor 10B according to a second modification example of the embodiment broken in the Y-Z plane similarly to FIG. 2 described above.

As shown in FIG. 6, the force sensor 10B according to the second modification example is formed, for example, in a multilayer structure of an elastic base material 51, a first insulation layer 53, a conductor layer 55, and a second insulation layer 57 that are sequentially laminated in the thickness direction.

The dielectric elastic base material 51 is, for example, a flexible dielectric such as a so-called thermosetting elastomer. The elastic base material 51 supports, for example, the first electrode 13 arranged inside the elastic base material 51.

The first insulation layer 53 and the second insulation layer 57 are, for example, insulators having flexibility and a stretch property such as a so-called flexible substrate. The first insulation layer 53 supports, for example, three second electrodes 15a, 15b, 15c that are exposed from a surface and are in contact with the elastic base material 51.

The conductor layer 55 is formed of, for example, a conductive material having flexibility and a stretch property such as a resin including a conductive metal filler. The conductor layer 55 is set to a reference potential, for example, by grounding or the like.

For example, three second conductor wires 19a, 19b, 19c penetrate through the conductor layer 55 along the thickness direction from three second electrodes 15a, 15b, 15c in the first insulation layer 53 and are arranged in the second insulation layer 57.

According to the second modification example, it is possible to form the shielding between each second electrode 15a, 15b, 15c and each second conductor wire 19a, 19b, 19c and the shielding among the three second conductor wires 19a, 19b, 19c, and it is possible to increase a S/N ratio of the force sensor 10B while preventing the size in the thickness direction from being increased.

The above embodiment is described using an example in which, in a plan view seen along the thickness direction, the array-type force sensor 30 includes a plurality of first electrodes 13 in a staggered arrangement in accordance with the plurality of electrode elements E in a staggered arrangement; however, the embodiment is not limited thereto. For example, in a plan view seen along the thickness direction, the plurality of first electrodes 13 may be aligned in a matrix form by rows and columns that are orthogonal to each other.

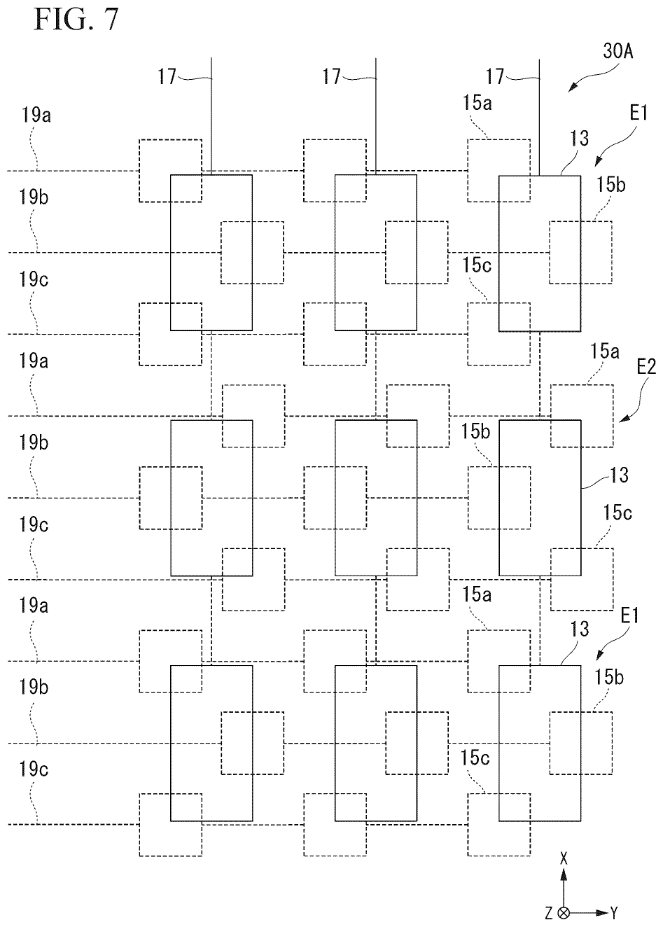

FIG. 7 is a configuration view of an array-type force sensor 30A according to a third modification example of the embodiment when seen along the thickness direction (Z-axis direction) similarly to FIG. 4 described above.

The force sensor 30A according to the third modification example includes, for example, a plurality of first electrode elements E1 and a plurality of second electrode elements E2 instead of the plurality of electrode elements E in the force sensor 30 of the embodiment described above. Each of the first electrode element E1 and the second electrode element E2 includes a first electrode 13 and three second electrodes 15 (15a, 15b, 15c). The first electrode element E1 and the second electrode element E2 include, for example, three second electrodes 15a, 15b, 15c arranged relative to the first electrode 13 so as to be line-symmetric with the X-axis as the axis of symmetry in a plan view seen along the thickness direction. For example, the first electrode element E1 is the same as the electrode element E of the embodiment described above.

For example, in a plan view seen along the thickness direction, the plurality of first electrode elements E1 and the plurality of second electrode elements E2 are arranged so as to be aligned and spaced at a predetermined interval in the Y-axis direction in an alternate row of a plurality of rows parallel to the Y-axis direction aligned to be spaced at a predetermined interval in the X-axis direction.

The plurality of first electrodes 13 are arranged, for example, so as to be aligned in a matrix form and spaced at a predetermined interval in each of the X-axis direction and the Y-axis direction. The plurality of first electrodes 13 aligned in series in the X-axis direction in each of the plurality of rows aligned in the Y-axis direction are connected, for example, by the first conductor wire 17 parallel to the X-axis direction.

The three second electrodes 15a, 15b, 15c of the plurality of sets are arranged, for example, so as to be aligned and spaced at a predetermined interval along the Y-axis direction in each of a plurality of rows parallel to the Y-axis direction aligned to be spaced at a predetermined interval in the X-axis direction. The plurality of second electrodes 15 are arranged, for example, in a so-called angular staggered (45-degree staggered) form such that an isosceles right triangle is formed when connecting the centers of the adjacent second electrodes 15 by line segments. For example, in each of a plurality of rows aligned in the X-axis direction, a plurality of second electrodes 15a are connected by a second conductor wire 19a parallel to the Y-axis direction, a plurality of second electrodes 15b are connected by a second conductor wire 19b parallel to the Y-axis direction, and a plurality of second electrodes 15c are connected by a second conductor wire 19c parallel to the Y-axis direction.

According to the third modification example, it is possible to prevent each first conductor wire 17 from becoming long compared to the embodiment described above. The above embodiment is described using an example in which the outer shape of each of the first electrode 31 and the second electrodes 15 is a rectangular plate shape; however, the embodiment is not limited thereto. The outer shape may be a plate formed of another shape other than the rectangular shape.

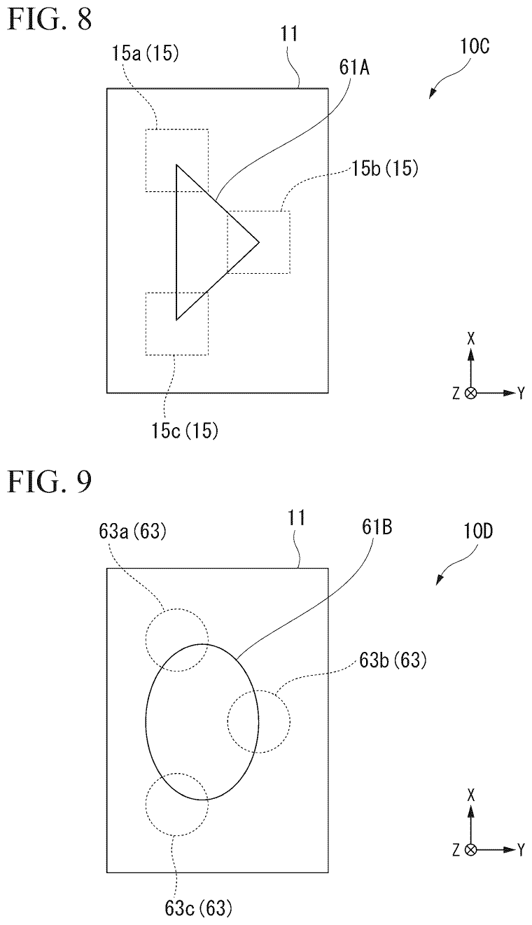

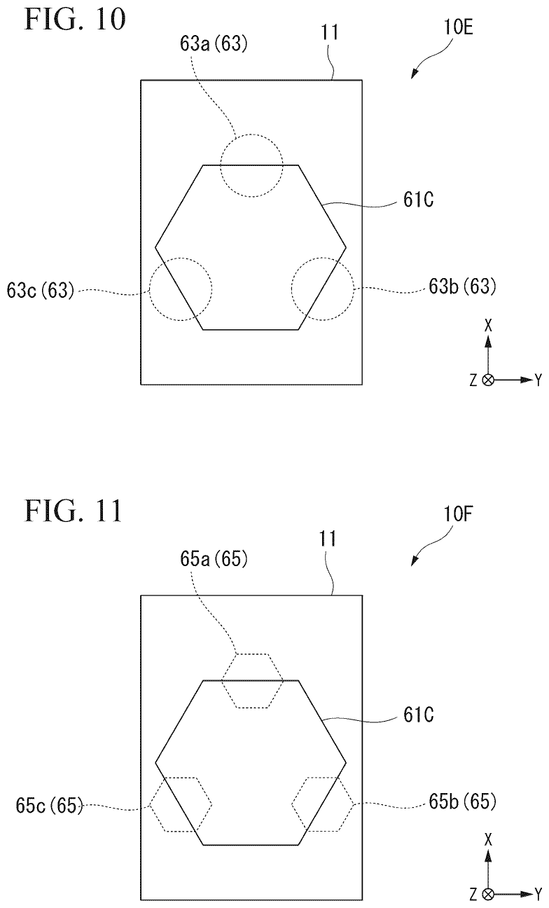

FIG. 8 is a configuration view of a force sensor 10C according to a fourth modification example of the embodiment when seen along the thickness direction (Z-axis direction). FIG. 9 is a configuration view of a force sensor 10D according to a fifth modification example of the embodiment when seen along the thickness direction (Z-axis direction). FIG. 10 is a configuration view of a force sensor 10E according to a sixth modification example of the embodiment when seen along the thickness direction (Z-axis direction). FIG. 11 is a configuration view of a force sensor 10F according to a seventh modification example of the embodiment when seen along the thickness direction (Z-axis direction).

As shown in FIG. 8, the outer shape of a first electrode 61A of the force sensor 10C according to the fourth modification example is a right-angled triangle plate shape.

In a plan view seen along the thickness direction in a state where an external force does not act, the three second electrodes 15a, 15b, 15c are arranged so as to overlap portions (for example, three apexes) of the first electrode 61A that are different from one another.

As shown in FIG. 9, the outer shape of a first electrode 61B of the force sensor 10D according to the fifth modification example is an elliptical plate shape, and the outer shape of three second electrodes 63 (63a, 63b, 63c) is a circular plate shape.

In a plan view seen along the thickness direction in a state where an external force does not act, the three second electrodes 63a, 63b, 63c are arranged so as to overlap portions (for example, both ends of a long axis and one end of a short axis) of the first electrode 61B that are different from one another.

In the force sensor 10C according to the fourth modification example and the force sensor 10D according to the fifth modification example, the respective three second electrodes 15, 63 are arranged such that an isosceles right triangle is formed when connecting the centers of the adjacent second electrodes 15 or the adjacent second electrodes 63 by line segments.

As shown in FIG. 10, the outer shape of a first electrode 61C of the force sensor 10E according to the sixth modification example is a regular hexagonal plate shape, and the outer shape of the three second electrodes 63 (63a, 63b, 63c) is a circular plate shape. In a plan view seen along the thickness direction in a state where an external force does not act, the three second electrodes 63a, 63b, 63c are arranged so as to overlap portions (for example, three sides) of the first electrode 61C that are different from one another. The areas and the shapes of regions where the respective three second electrodes 63a, 63b, 63c overlap the first electrode 61C are identical.

As shown in FIG. 11, the outer shape of a first electrode 61C of the force sensor 10E according to the seventh modification example is a regular hexagonal plate shape, and the outer shape of the three second electrodes 65 (65a, 65b, 65c) is a regular hexagonal plate shape. In a plan view seen along the thickness direction in a state where an external force does not act, the three second electrodes 65a, 65b, 65c are arranged so as to overlap portions (for example, three sides) of the first electrode 61C that are different from one another. The areas and the shapes of regions where the respective three second electrodes 65a, 65b, 65c overlap the first electrode 61C are identical.

In the force sensor 10E according to the sixth modification example and the force sensor 10F according to the seventh modification example, the respective three second electrodes 63, 65 are arranged in a so-called 120° phase such that an equilateral triangle is formed when connecting the centers of the adjacent second electrodes 63 or the adjacent second electrodes 65 by line segments.

In the force sensor 10E according to the sixth modification example and the force sensor 10F according to the seventh modification example, in a plan view seen along the thickness direction, the areas and the shapes of regions where the respective second electrodes 63 or the respective second electrodes 65 overlap the first electrode 61C are identical, and thereby, each correction coefficient ηa, ηb, ηc with respect to each capacitance Ca, Cb, Cc as in the embodiment described above is 1.

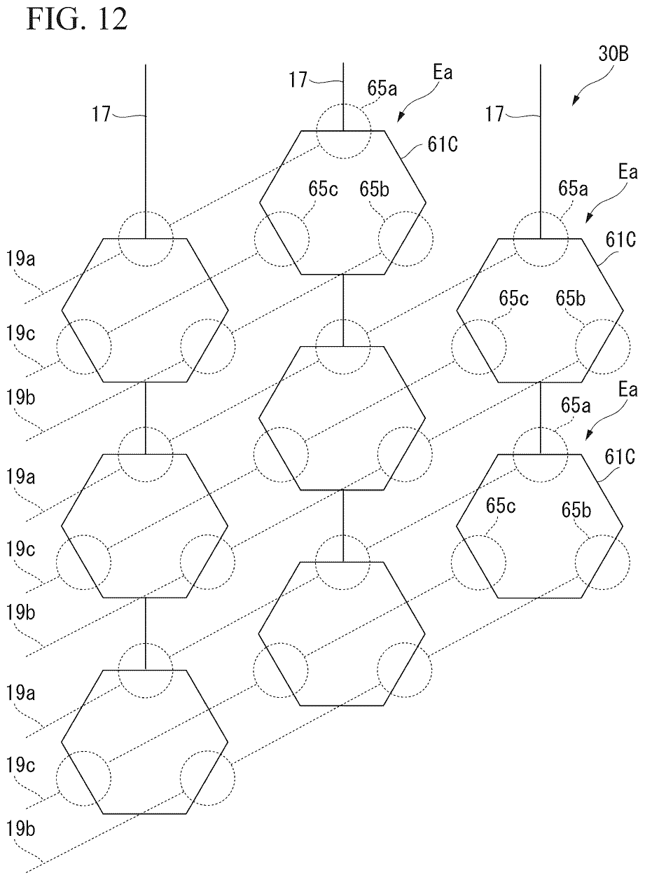

FIG. 12 is a configuration view of an array-type force sensor 30B according to the seventh modification example of the embodiment when seen along the thickness direction (Z-axis direction).

As shown in FIG. 12, the array-type force sensor 30B according to the seventh modification example includes, for example, a plurality of electrode elements Ea. The plurality of electrode elements Ea are arranged, for example, in a so-called 60-degree staggered form such that an equilateral triangle is formed when connecting the centers of the adjacent electrode elements Ea by line segments. Each electrode element Ea includes a first electrode 61C and three second electrodes 65 (65a, 65b, 65c). The plurality of first electrodes 61C and the plurality of second electrodes 65 are arranged in a so-called 60-degree staggered form.

For example, the plurality of first electrodes 61C are connected by a plurality of first conductor wires 17 parallel to an X-axis line (first straight line). The plurality of second electrodes 65a are connected by a second conductor wire 19a parallel to a second straight line. The plurality of second electrodes 65b are connected by a second conductor wire 19b parallel to the second straight line. The plurality of second electrodes 65c are connected by a second conductor wire 19c parallel to the second straight line. The first straight line and the second straight line intersect each other at, for example, 60 degrees.

According to the seventh modification example, compared to the embodiment and the third modification example described above, it is possible to arrange a plurality of electrode elements Ea at a high density, and it is possible to prevent the layout in a small space in a portion where a layout space is limited, for example, of a robot hand or the like from becoming difficult.

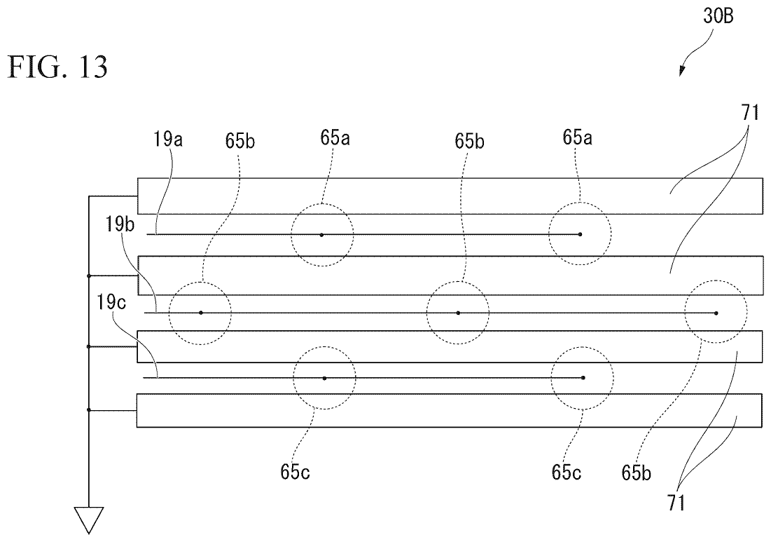

FIG. 13 is a cross-sectional view showing part of the array-type force sensor 30B according to the seventh modification example of the embodiment broken in a X-Y plane.

As shown in FIG. 13, the array-type force sensor 30B according to the seventh modification example may include, for example, a plurality of conductor layers 71 that shield each of three adjacent second conductor wires 19a, 19b, 19c, in the same plane (X-Y plane) in addition to the multilayer structure in the thickness direction as in the force sensor 10B according to the second modification example shown in FIG. 6 described above. Each of the plurality of conductor layers 71 is formed of, for example, a conductive material having flexibility and a stretch property such as a resin including a conductive metal filler. Each conductor layer 71 is set to a reference potential, for example, by grounding or the like. The plurality of conductor layers 71 are arranged, for example, so as to sandwich each of the three second conductor wires 19a, 19b, 19c from both sides in the X-axis direction.

According to the seventh modification example, it is possible to form the shielding between each second electrode 65a, 65b, 65c and each second conductor wire 19a, 19b, 19c and the shielding among the three second conductor wires 19a, 19b, 19c, and it is possible to increase the S/N ratio of the force sensor 30B.

In the embodiment described above, at least any of the shape and the size of each of the three second electrodes 15 (15a, 15b, 15c) may not be identical to one another and may have, for example, shapes, sizes, or the like that are different from one another.

In the embodiment described above, for example, in a plan view seen along the thickness direction, the plurality of electrode elements E, the plurality of respective electrode elements E1, E2, or the plurality of electrode elements Ea may be aligned in a suitably regular manner, such as a suitable staggered arrangement, an alignment along rows and columns that are orthogonal to or obliquely intersect each other, an alignment along circumferences of concentric circles or a suitable graphic, or the like.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and gist of the invention and are also included within the scope of the invention described in the appended claims and equivalents thereof.

What is claimed is:

1. A force sensor comprising:
a dielectric elastic base material; and
a first electrode and three second electrodes that sandwich the elastic base material from both sides in a predetermined direction,
wherein in a plan view seen along the predetermined direction,
the three second electrodes are arranged to overlap portions of the first electrode that are different from one another, and
in each case where an external force acts on the elastic base material along each of a first direction and a second direction that form a predetermined angle on a plane orthogonal to the predetermined direction, among areas of the portions where each of the three second electrodes overlaps the first electrode, the areas corresponding to at least two of the second electrodes change.

2. A force sensor comprising:
a dielectric elastic base material; and
a plurality of electrode elements that are integrally aligned, each of the plurality of electrode elements being a combination of a first electrode and three second electrodes that sandwich the elastic base material from both sides in a predetermined direction,
wherein in a plan view seen along the predetermined direction,
the three second electrodes are arranged to overlap portions of the first electrode that are different from one another in each the plurality of electrode elements, and
each of the three second electrodes in the plurality of electrode elements is aligned along three different straight lines that are parallel to one another.

3. The force sensor according to claim 1, further comprising:
a process portion that sets, with reference to any one of the three second electrodes, a correction coefficient of a capacitance to other two second electrodes in accordance with the areas of the portions where each of the three second electrodes overlaps the first electrode, and acquires an external force that acts on the elastic base material based on the correction coefficient and the capacitance of each of the three second electrodes.

4. The force sensor according to claim 2, further comprising:
a process portion that sets, with reference to any one of the three second electrodes, a correction coefficient of a capacitance to other two second electrodes in accordance with the areas of the portions where each of the three second electrodes overlaps the first electrode, and acquires an external force that acts on the elastic base material based on the correction coefficient and the capacitance of each of the three second electrodes.
